(19) United States
(12) Patent Application Publication
(10) Pub. No.: US 2025/0387785 A1
(43) Pub. Date: Dec. 25, 2025

(54) USE OF CARBON DIOXIDE AND OXYGEN IN THE REGENERATION OF THE ACID CONDENSATION CATALYST

(71) Applicants: Johnson Matthey Public Limited Company, London (GB); Virent Inc., Madison, WI (US)

(72) Inventors: Ian Campbell, London (GB); Rauf Edward John Gearing, London (GB); Akhilesh Chandra, London (GB); Matthew Van Straten, Madison, WI (US); Andrew Held, Madison, WI (US)

(21) Appl. No.: 19/244,378

(22) Filed: Jun. 20, 2025

Related U.S. Application Data
(60) Provisional application No. 63/662,753, filed on Jun. 21, 2024.

(51) Int. Cl. B01J 38/40; C10G 3/00

(52) U.S. Cl. CPC B01J 38/40; C10G 3/62; C10G 2300/1011; C10G 2300/703

(57) ABSTRACT

The present disclosure provides a method for regenerating an acid condensation catalyst including reacting a fouled acid condensation catalyst in an acid condensation (AC) reactor with a regeneration feed gas comprising oxygen (O₂) at a regeneration temperature to produce a regenerated acid condensation catalyst and an effluent gas comprising carbon dioxide (CO₂). The method further includes fractionating the effluent gas into a liquid phase containing water and a vapor phase, (iii) mixing at least a portion of the vapor phase with O₂, CO₂, air, or a combination thereof to form the regeneration feed gas; and (iv) introducing the regeneration feed gas to the AC reactor to continue the reaction of step (i).

### CROSS REFERENCE TO RELATED APPLICATIONS

This application claims the benefit of priority to U.S. Provisional Application No. 63/662,753, filed Jun. 21, 2024, the entire contents of which is incorporated by reference herein.

### BACKGROUND

Significant amount of attention has been placed on developing new technologies for more efficient energy production. Bioreforming processes can produce aromatic hydrocarbons and other useful compounds from biomass feedstocks, including cellulose, hemicellulose, and lignin. For instance, cellulose and hemicellulose can be used as feedstock for various bioreforming processes, including aqueous phase reforming (APR) and hydrodeoxygenation (HDO)—catalytic reforming processes that, when integrated with hydrogenation, can convert cellulose and hemicellulose into an array of products, including hydrogen, liquid fuels, aromatics, kerosene, diesel fuel, lubricants, and fuel oils, among others. In addition, catalytic acid condensation (AC) can be used to convert oxygenates (e.g., generated by HDO) or other compounds into hydrocarbons.

APR and HDO methods and techniques are described in U.S. Pat. Nos. 6,699,457; 6,964,757; 6,964,758; and 7,618,612 (all to Cortright et al., entitled “Low-Temperature Hydrogen Production from Oxygenated Hydrocarbons”); U.S. Pat. No. 6,953,873 (to Cortright et al., entitled “Low-Temperature Hydrocarbon Production from Oxygenated Hydrocarbons”); and U.S. Pat. Nos. 7,767,867; 7,989,664; and 8,198,486 (all to Cortright, entitled “Methods and Systems for Generating Polyols”), all of which are incorporated herein by reference. Various other APR and HDO methods and techniques are also described in U.S. Pat. Nos. 8,053,615; 8,017,818; 7,977,517; 8,362,307; 8,367,882; and 8,455,705 (all to Cortright and Blommel, entitled “Synthesis of Liquid Fuels and Chemicals from Oxygenated Hydrocarbons”); U.S. Pat. No. 8,231,857 (to Cortright, and entitled “Catalysts and Methods for Reforming Oxygenated Compounds”); U.S. Pat. No. 8,350,108 (to Cortright et al., entitled “Synthesis of Liquid Fuels from Biomass”); and International Patent Application No. PCT/US2008/056330 (to Cortright and Blommel, entitled “Synthesis of Liquid Fuels and Chemicals from Oxygenated Hydrocarbons” and published as WO2008109877A1), all of which are incorporated herein by reference.

It is well established, that coking leads to the deactivation of acid condensation catalysts. This phenomenon is a ubiquitous problem in the modern petrochemical and energy transformation industries. The acid condensation catalyst gradually accumulates deposits of coke as the reaction proceeds. The activity of the catalyst gradually declines due to the buildup of coke. Coke formation is believed to result from the deposition of coke precursors including high molecular weight materials and condensed ring aromatic molecules on the catalyst, these polymerizing to form coke. Eventually, economics dictates the necessity of reactivating the catalyst. Consequently, in all processes of this type the catalyst must necessarily be periodically regenerated by burning the coke off the catalyst at controlled conditions, this constituting an initial phase of catalyst reactivation.

Accordingly, there is a need for cost-effective and efficient methods of regenerating acid condensation catalysts.

### SUMMARY OF THE INVENTION

Some aspects of the present disclosure provide a method of regenerating an acid condensation (AC) catalyst, the method including (i) reacting a fouled acid condensation catalyst in an AC reactor with a regeneration feed gas comprising oxygen (O₂) at a regeneration temperature to produce a regenerated acid condensation catalyst and an effluent gas comprising carbon dioxide (CO₂); (ii) fractionating the effluent gas into a liquid phase containing water and a vapor phase; (iii) mixing at least a portion of the vapor phase with O₂, CO₂, air, or a combination thereof to form the regeneration feed gas; and (iv) introducing the regeneration feed gas to the AC reactor to continue the reaction of step (i).

The regeneration gas can be heated by the effluent gas in a heat exchanger before entering the AC reactor as the regeneration gas. The regeneration gas can be heated by a heater to an inlet temperature of about 350° C. to about 500° C.

The vapor phase can be mixed with O₂, or air, or O₂ and CO₂ in step (iii). The vapor phase can be compressed by a compressor before the mixing in step (iii).

The level of O₂ in the regeneration feed gas can be about 0.5 vol % to about 5.0 vol %, such as about 1.0 vol % to about 1.5 vol %. The level of CO₂ in the regeneration feed gas can be about 5 vol % to about 99 vol %, such as about 90 vol % to about 99 vol %. The regeneration feed gas can have an inlet gas heat capacity of about 30 kJ/kmol·K to about 50 kJ/kmol·K.

The effluent gas exiting the AC reactor can have a temperature of about 470° C. to about 560° C. The effluent gas can be cooled to about 40° C. before being fractionated in step (ii). A portion of the vapor phase from step (ii) can be purged and the remaining vapor phase can be used in step (iii).

Some aspects of the present disclosure provide a method of producing a C₄₊ compound, including (i) reacting a feed stream comprising C₁₊O₁₋₃ hydrocarbons in the presence of an acid condensation catalyst at a condensation temperature and condensation pressure to produce an AC product stream comprising the C₄₊ compound and a fouled acid condensation catalyst; (ii) regenerating the fouled acid condensation catalyst according to the method of claim 1 to produce a regenerated acid condensation catalyst; and (iii) continue reacting the feed stream in the presence of the regenerated acid condensation catalyst to further produce the AC product stream comprising the C₄₊ compound.

### BRIEF DESCRIPTION OF DRAWINGS

FIG. 1 shows a schematic illustration of a method in accordance with some embodiments of the present disclosure.

FIG. 2 shows a schematic illustration of a method in accordance with some embodiments of the present disclosure.

FIG. 3 shows a comparison of combustion exotherms from 3 different regenerations in Reactor A. Notable conditions are listed above each regeneration. The timescale on x-axis is not continuous for all regenerations. Each of these regenerations is cropped to fit closely on this chart for ease of comparison. Each line represents an internal reactor thermocouple reading.

FIG. 4 shows a comparison of combustion exotherms from 4 different regenerations in Reactor C. Notable conditions are listed above each regeneration. The timescale on x-axis is not continuous for all regenerations. Each of these regenerations is cropped to fit closely on this chart for ease of comparison. Each line represents an internal reactor thermocouple reading.

### DETAILED DESCRIPTION OF THE INVENTION

Disclosed herein are methods of regenerating an acid condensation catalyst. The methods disclosed herein provide for cost-effective, efficient methods of regenerating acid condensation catalysts.

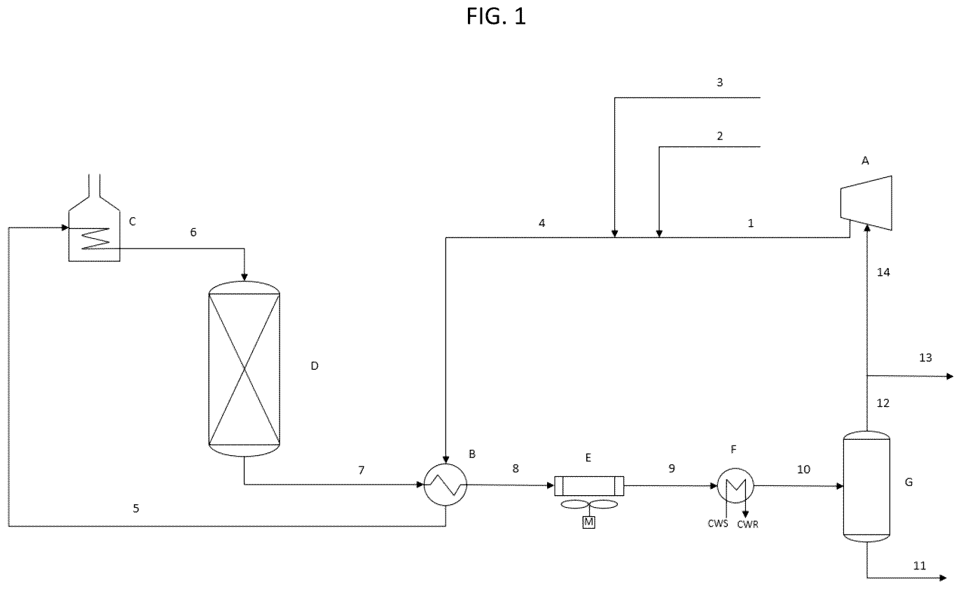

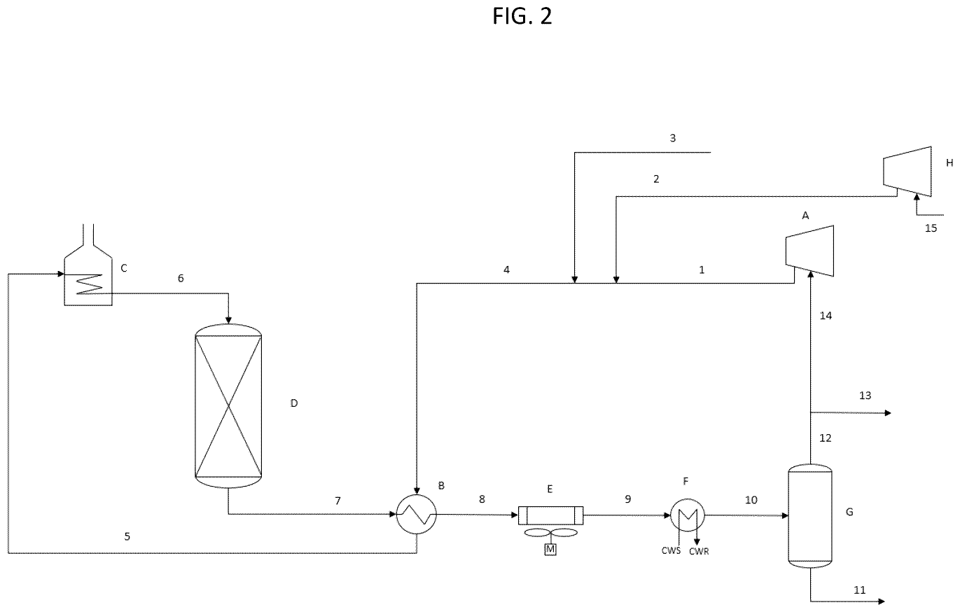

Referring to FIGS. 1-2, the method includes reacting a fouled acid condensation catalyst in an acid condensation (AC) reactor (D) with a regeneration feed gas comprising oxygen (O₂) (6) at a regeneration temperature to produce a regenerated acid condensation catalyst and an effluent gas comprising carbon dioxide (CO₂) (7). The method further includes fractionating the effluent gas into a liquid phase containing water (11) and a vapor phase (14), (iii) mixing at least a portion of the vapor phase (14) with O₂, CO₂, air, or a combination thereof to form the regeneration feed gas (4); and (iv) introducing the regeneration feed gas to the AC reactor (D) to continue the reaction of step (i).

Further disclosed herein is a method of producing a C₄₊ compound, including (i) reacting a feed stream comprising C₁₊O₁₋₃ hydrocarbons in the presence of an acid condensation catalyst at a condensation temperature and condensation pressure to produce an AC product stream comprising the C₄₊ compound and a fouled acid condensation catalyst; (ii) regenerating the fouled acid condensation catalyst according to the methods described above to produce a regenerated acid condensation catalyst; and (iii) continue reacting the feed stream in the presence of the regenerated acid condensation catalyst to further produce the AC product stream comprising the C₄₊ compound.

The methods disclosed herein include a fouled acid condensation catalyst. The technology disclosed herein can be used to regenerate AC catalyst fouled during processing of a wide range of feed streams. As an example context, AC processing of hydrodeoxygenation (HDO) products, with the relevant HDO reactions being implemented for a feed stream from an upstream hydrogenation reactor system (not shown), are considered. A wide variety of systems can be implemented to provide a feed stream to an AC reactor system (e.g., as variously disclosed in U.S. Pat. Nos. 6,699,457; 6,964,757; 6,964,758; 7,618,612; 6,953,873; 7,767,867; 7,989,664; 6,953,873; 7,767,867; 7,989,664; 8,198,486; 8,053,615; 8,017,818; 7,977,517; 8,362,307; 8,367,882; 8,455,705 8,231,857; and 8,350,108; in International Patent Publication WO2008109877A1; or as otherwise known in the art). In some cases, the feed stream is derived from biomass. In some cases, the biomass feedstock includes cellulose, hemicellulose, and lignin. For instance, cellulose and hemicellulose.

The methods disclosed herein include regenerating a fouled acid condensation catalyst in an acid condensation (AC) reactor (D) with a regeneration feed gas including oxygen (O₂). In some cases, the regeneration feed gas includes an oxygen concentration from about 0.1 vol % to about 5.0 vol %, from about 0.5 vol % to about 5.0 vol %, from about 0.5 vol % to about 2.5 vol %, from about 0.5 vol % to about 1.5 vol %, from about 0.8 vol % to about 1.5 vol %, from about 0.9 vol % to about 1.5 vol %, or from about 1.0 vol % to about 1.5 vol %. In some cases, the regeneration feed gas includes a carbon dioxide concentration from about 1.00 vol % to about 99.5 vol %, from about 5 vol % to about 99 vol %, from about 10 vol % to about 99 vol %, from about 15 vol % to about 99 vol %, from about 30 vol % to about 99 vol %, from about 50 vol % to about 99 vol %, from about 70 vol % to about 99 vol %, or from about 90 vol % to about 99 vol %. The content of carbon dioxide in the regeneration feed gas can be at least 10 vol %, at least 20 vol %, at least 30 vol %, at least 40 vol %, at least 50 vol %, at least 60 vol %, at least 70 vol %, at least 80 vol %, at least 90 vol %, at least 92 vol %, at least 95 vol %, or at least 98 vol %. The addition of CO₂ in the regeneration feed gas may result in a reduction of regeneration gas circulation. For example, an increase of CO₂ content from 17 vol % to 25 vol % may allow for a 5% reduction in regeneration gas circulation and a CO₂ content of 30 vol % may allow a 10% reduction regeneration gas circulation. In various embodiments, higher CO₂ contents are employed to allow a greater reduction in regeneration gas flow. In some embodiments, the content of carbon dioxide in the regeneration feed gas can be at least 30 vol %, such as at least 50 vol %, at least 70 vol %, at least 90 vol %, or at least 95 vol %.

The methods disclosed herein include a regeneration temperature. The regeneration temperature may vary with conditions of the regeneration method. For example, the regeneration temperature may be characterized by an inlet temperature of the AC reactor, an exit temperature of the AC reactor, the AC reactor exotherm, and an AC reactor bed temperature. In some cases, regeneration of the AC catalyst begins with coke burning at about 385° C. In some cases, the reactor bed temperature may be maintained below 540° C. In some cases, the regeneration gas (4) is heated before entering the AC reactor as the regeneration gas. Heating may be accomplished by a device configured to transfer heat from one medium to another. In some cases, the regeneration gas (4) is heated by the effluent gas (7) in a heat exchanger before entering the AC reactor as the regeneration gas. In some cases, the regeneration gas (streams 4 or 5) is heated by a heater to an inlet temperature of about 350° C. to about 500, about 350° C. to about 480° C., about 350° C. to about 450° C., or about 350° C. to about 400° C. In some cases, the inlet temperature may be increased to above 400° C. in order to maintain full oxygen consumption. In some cases, the inlet temperature is increased to about 420° C., about 430° C., about 440° C., about 450° C., about 460° C., about 470° C., or about 480° C. In some cases, the regeneration feed gas has an inlet gas heat capacity from about 20 kJ/kmol·K to about 60 kJ/kmol·K, from about 25 kJ/kmol·K to about 50 kJ/kmol·K, from about 30 kJ/kmol·K to about 40 kJ/kmol·K, or from about 32 kJ/kmol·K to about 50 kJ/kmol·K.

Referring to FIG. 1, the methods disclosed herein include fractionating the effluent gas (7) from the AC reactor into a liquid phase containing water (11) and a vapor phase (14), (iii) mixing at least a portion of the vapor phase (14) with O₂, CO₂, air, or a combination thereof to form the regeneration feed gas (4). In some case, the vapor phase is mixed with O₂. In some case, the vapor phase is mixed with air. In some case, the vapor phase is mixed with O₂ and CO₂. In some cases, the vapor phase is mixed with air and CO₂. Referring to FIGS. 1 and 2, in some cases, the vapor phase (14) may be compressed by a compressor (A). In some cases, the vapor phase is compressed by a compressor before mixing at least a portion of the vapor phase (14) with O₂, CO₂, air, or a combination thereof to form the regeneration feed gas (4).

Referring now to FIGS. 1-2, the effluent gas (7) exiting the AC reactor may have a temperature from about 450° C. to about 560° C., from about 470° C. to about 520° C., from about 480° C. to about 500° C., or from about 490° C. to about 500° C. In some cases, the effluent gas is cooled to below about 150° C., such as about 100° C., about 75° C., about 50° C., about 45° C., or about 40° C. In some cases, the the effluent gas (7) exiting the AC reactor may be cooled in advance of being fractionated into a liquid phase containing water (11) and a vapor phase (14). Referring still to FIGS. 1-2, a portion of the vapor phase produced from fractionating the effluent gas into a liquid phase containing water (11) and a vapor phase (14) may be purged and the remaining vapor phase may be used in mixing at least a portion of the vapor phase (14) with O₂, CO₂, air, or a combination thereof to form the regeneration feed gas (4).

### AC Catalyst and AC Reactions

In some examples, reacting the HDO product stream (or another product stream) in the presence of a condensation catalyst (i.e., in the AC reactor, D) can produce a C₄₊ compound. The C₄₊ compound can include a member selected from the group consisting of C₄₊ alcohol, C₄₊ ketone, C₄₊ alkane, C₄₊ alkene, C₅₊ cycloalkane, C₅₊ cycloalkene, aryl, fused aryl, and a mixture thereof. In one exemplary embodiment, the C₄₊ alkane comprises a branched or straight chain C₄₋₃₀ alkane, or a branched or straight chain C₄₋₉, C₇₋₁₄, C₁₂₋₂₄ alkane, or a mixture thereof. In another exemplary embodiment, the C₄₊ alkene comprises a branched or straight chain C₄₋₃₀ alkene, or a branched or straight chain C₄₋₉, C₇₋₁₄, C₁₂₋₂₄ alkene, or a mixture thereof. In another exemplary embodiment, the C₅₊ cycloalkane comprises a mono-substituted or multi-substituted C₅₊ cycloalkane, and at least one substituted group is a branched C₃₊ alkyl, a straight chain C₁₊ alkyl, a branched C₃₊ alkylene, a straight chain C₁₊ alkylene, a phenyl, or a combination thereof, or a branched C₃₋₁₂ alkyl, a straight chain C₁₋₁₂ alkyl, a branched C₃₋₁₂ alkylene, a straight chain C₁₋₁₂ alkylene, a phenyl, or a combination thereof, or a branched C₃₋₄ alkyl, a straight chain C₁₋₄ alkyl, a branched C₃₋₄ alkylene, straight chain C₁₋₄ alkylene, a phenyl, or a combination thereof. In another exemplary embodiment, the C₅₊ cycloalkene comprises a mono-substituted or multi-substituted C₅₊ cycloalkene, and at least one substituted group is a branched C₃₊ alkyl, a straight chain C₁₊ alkyl, a branched C₃₊ alkylene, a straight chain C₂₊ alkylene, a phenyl, or a combination thereof, or a branched C₃₋₁₂ alkyl, a straight chain C₁₋₁₂ alkyl, a branched C₃₋₁₂ alkylene, a straight chain C₂₋₁₂ alkylene, a phenyl, or a combination thereof, or a branched C₃₋₄ alkyl, a straight chain C₁₋₄ alkyl, a branched C₃₋₄ alkylene, straight chain C₂₋₄ alkylene, a phenyl, or a combination thereof. In another exemplary embodiment, the aryl comprises an unsubstituted aryl, or a mono-substituted or multi-substituted aryl, and at least one substituted group is a branched C₃₊ alkyl, a straight chain C₁₊ alkyl, a branched C₃₊ alkylene, a straight chain C₂₊ alkylene, a phenyl, or a combination thereof, or a branched C₃₋₁₂ alkyl, a straight chain C₁₋₁₂ alkyl, a branched C₃₋₁₂ alkylene, a straight chain C₂₋₁₂ alkylene, a phenyl, or a combination thereof, or a branched C₃₋₄ alkyl, a straight chain C₁₋₄ alkyl, a branched C₃₋₄ alkylene, a straight chain C₂₋₄ alkylene, a phenyl, or a combination thereof. In another exemplary embodiment, the fused aryl comprises an unsubstituted fused aryl, or a mono-substituted or multi-substituted fused aryl, and at least one substituted group is a branched C₃₊ alkyl, a straight chain C₁₊ alkyl, a branched C₃₊ alkylene, a straight chain C₂₊ alkylene, a phenyl, or a combination thereof, or a branched C₃₋₄ alkyl, a straight chain C₁₋₄ alkyl, a branched C₃₋₄ alkylene, a straight chain C₂₋₄ alkylene, a phenyl, or a combination thereof. In another exemplary embodiment, the C₄₊ alcohol comprises a compound according to the formula R¹—OH, wherein R¹ is a branched C₄₊ alkyl, straight chain C₄₊ alkyl, a branched C₄₊ alkylene, a straight chain C₄₊ alkylene, a substituted C₅₊ cycloalkane, an unsubstituted C₅₊ cycloalkane, a substituted C₅₊ cycloalkene, an unsubstituted C₅₊ cycloalkene, an aryl, a phenyl, or a combination thereof.

In another exemplary embodiment of method of making the C₄₊ compound, the C₄₊ ketone comprises a compound according to the formula

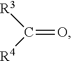

wherein R³ and R⁴ are independently a branched C₃₊ alkyl, a straight chain C₁₊ alkyl, a branched C₃₊ alkylene, a straight chain C₂₊ alkylene, a substituted C₅₊ cycloalkane, an unsubstituted C₅₊ cycloalkane, a substituted C₅₊ cycloalkene, an unsubstituted C₅₊ cycloalkene, an aryl, a phenyl, or a combination thereof. Examples of desirable C₄₊ ketones include, without limitation, butanone, pentanone, hexanone, heptanone, octanone, nonanone, decanone, undecanone, dodecanone, tridecanone, tetradecanone, pentadecanone, hexadecanone, heptyldecanone, octyldecanone, nonyldecanone, eicosanone, uneicosanone, doeicosanone, trieicosanone, tetraeicosanone, or isomers thereof.

The condensation catalyst is generally a catalyst capable of forming longer chain compounds by linking two molecules (e.g., oxygen containing species or other functionalized compounds, including olefins) through a new carbon-carbon bond, and converting the resulting compound to a hydrocarbon, alcohol, or ketone. In some embodiments, the condensation catalyst is an acid condensation catalyst. The condensation catalyst may include, without limitation, carbides, nitrides, zirconia, alumina, silica, aluminosilicates, phosphates, zeolites (e.g., ZSM-5, ZSM-11, ZSM-12, ZSM-22, ZSM-23, ZSM-35 and ZSM-48), titanium oxides, zinc oxides, vanadium oxides, lanthanum oxides, yttrium oxides, scandium oxides, magnesium oxides, cerium oxides, barium oxides, calcium oxides, hydroxides, heteropolyacids, inorganic acids, acid modified resins, base modified resins, and combinations thereof. The condensation catalyst may include the above alone or in combination with a modifier, such as Ce, La, Y, Sc, P, B, Bi, Li, Na, K, Rb, Cs, Mg, Ca, Sr, Ba, and combinations thereof. The condensation catalyst may also include a metal, such as Cu, Ag, Au, Pt, Ni, Fe, Co, Ru, Zn, Cd, Ga, In, Rh, Pd, Ir, Re, Mn, Cr, Mo, W, Sn, Os, alloys and combinations thereof, to provide a metal functionality.

The condensation catalyst may be self-supporting (i.e., the catalyst does not need another material to serve as a support) or may require a separate support suitable for suspending the catalyst in the reactant stream. One particularly beneficial support is silica, especially silica having a high surface area (greater than 100 square meters per gram), obtained by sol-gel synthesis, precipitation or fuming. In other embodiments, particularly when the condensation catalyst is a powder, the catalyst system may include a binder to assist in forming the catalyst into a desirable catalyst shape. Applicable forming processes include extrusion, pelletization, oil dropping, or other known processes. Zinc oxide, alumina, and a peptizing agent may also be mixed together and extruded to produce a formed material. After drying, this material is calcined at a temperature appropriate for formation of the catalytically active phase, which usually requires temperatures in excess of 450° C.

The condensation catalyst may include one or more zeolite structures comprising cage-like structures of silica-alumina. Zeolites are crystalline microporous materials with well-defined pore structures. Zeolites contain active sites, usually acid sites, which can be generated in the zeolite framework. The strength and concentration of the active sites can be tailored for particular applications. Examples of suitable zeolites for condensing secondary alcohols and alkanes may comprise aluminosilicates, optionally modified with cations, such as Ga, In, Zn, Mo, and mixtures of such cations, as described, for example, in U.S. Pat. No. 3,702,886, which is incorporated herein by reference. As recognized in the art, the structure of the particular zeolite or zeolites may be altered to provide different amounts of various hydrocarbon species in the product mixture. Depending on the structure of the zeolite catalyst, the product mixture may contain various amounts of aromatic and cyclic hydrocarbons.

Examples of suitable zeolite catalysts include ZSM-5, ZSM-11, ZSM-12, ZSM-22, ZSM-23, ZSM-35 and ZSM-48. Zeolite ZSM-5, and the conventional preparation thereof, is described in U.S. Pat. No. 3,702,886; Re. 29,948 (highly siliceous ZSM-5); U.S. Pat. Nos. 4,100,262 and 4,139,600, all incorporated herein by reference. Zeolite ZSM-11, and the conventional preparation thereof, is described in U.S. Pat. No. 3,709,979, which is also incorporated herein by reference. Zeolite ZSM-12, and the conventional preparation thereof, is described in U.S. Pat. No. 3,832,449, incorporated herein by reference. Zeolite ZSM-23, and the conventional preparation thereof, is described in U.S. Pat. No. 4,076,842, incorporated herein by reference. Zeolite ZSM-35, and the conventional preparation thereof, is described in U.S. Pat. No. 4,016,245, incorporated herein by reference. Another preparation of ZSM-35 is described in U.S. Pat. No. 4,107,195, the disclosure of which is incorporated herein by reference. ZSM-48, and the conventional preparation thereof, is taught by U.S. Pat. No. 4,375,573, incorporated herein by reference. Other examples of zeolite catalysts are described in U.S. Pat. Nos. 5,019,663 and 7,022,888, also incorporated herein by reference. An exemplary condensation catalyst is a ZSM-5 zeolite modified with Cu, Pd, Ag, Pt, Ru, Re, Ni, Sn, or combinations thereof.

As described in U.S. Pat. No. 7,022,888, which is incorporated herein by reference, the condensation catalyst may be a bifunctional pentasil zeolite catalyst including at least one metallic element from the group of Cu, Ag, Au, Pt, Ni, Fe, Co, Ru, Zn, Cd, In, Rh, Pd, Ir, Re, Mn, Cr, Mo, W, Sn, Os, alloys and combinations thereof, or a modifier from the group of In, Zn, Fe, Mo, Au, Ag, Y, Sc, Ni, P, Ta, lanthanides, and combinations thereof. The zeolite may have strong acidic sites, and may be used with reactant streams containing an oxygenated hydrocarbon at a temperature of below 580° C. The bifunctional pentasil zeolite may have ZSM-5, ZSM-8 or ZSM-11 type crystal structure consisting of a large number of 5-membered oxygen-rings (i.e., pentasil rings). In one embodiment the zeolite will have a ZSM-5 type structure.

Alternatively, solid acid catalysts such as alumina modified with phosphates, chloride, silica, and other acidic oxides may be used. Also, sulfated zirconia, phosphated zirconia, titania zirconia, or tungstated zirconia may provide the necessary acidity. Re and Pt/Re catalysts are also useful for promoting condensation of oxygenates to C₅₊ hydrocarbons and/or C₅₊ mono-oxygenates. The Re is sufficiently acidic to promote acid-catalyzed condensation. In certain embodiments, acidity may also be added to activated carbon by the addition of either sulfates or phosphates.

The specific C₄₊ compounds produced will depend on various factors, including, without limitation, the type of oxygenated compounds in the reactant stream, condensation temperature, condensation pressure, the reactivity of the catalyst, and the flow rate of the reactant stream as it affects the space velocity, GHSV, LHSV, and WHSV. In certain embodiments, the reactant stream is contacted with the condensation catalyst at a WHSV that is appropriate to produce the desired hydrocarbon products. In one embodiment the WHSV is at least 0.1 grams of volatile (C₂₊ O₁₋₃) oxygenates in the reactant stream per gram catalyst per hour. In another embodiment the WHSV is between 0.1 to 10.0 g/g hr, including a WHSV of 1, 2, 3, 4, 5, 6, 7, 8, 9, 10 g/g hr, and increments between.

In certain embodiments the condensation reaction is carried out at a temperature and pressure at which the thermodynamics of the proposed reaction are favorable. For volatile C₂₊O₁₋₃ oxygenates the reaction may be carried out at a temperature where the vapor pressure of the volatile oxygenates is at least 0.1 atm (and preferably a good deal higher). The condensation temperature will vary depending upon the specific composition of the oxygenated compounds. The condensation temperature will generally be greater than 80° C., or 100° C., or 125° C., or 150° C., or 175° C., or 200° C., or 225° C., or 250° C., and less than 500° C., or 450° C., or 425° C., or 375° C., or 325° C., or 275° C. For example, the condensation temperature may be between 80° C. to 500° C., or between 125° C. to 450° C., or between 250° C. to 425° C. The condensation pressure will generally be greater than 0 psig, or 10 psig, or 100 psig, or 200 psig, and less than 2000 psig, or 1800 psig or, or 1600 psig, or 1500 psig, or 1400 psig, or 1300 psig, or 1200 psig, or 1100 psig, or 1000 psig, or 900 psig, or 700 psig. For example, the condensation pressure may be greater than 0.1 atm, or between 0 and 1500 psig, or between 0 and 1200 psig.

C₄₊ alkanes and C₄₊ alkenes produced from acid condensation can have from 4 to 30 carbon atoms (C₄₊ alkanes and C₄₊ alkenes) and may be branched or straight chained alkanes or alkenes. The C₄₊ alkanes and C₄₊ alkenes may also include fractions of C₄₋₉, C₇₋₁₄, C₁₂₋₂₄ alkanes and alkenes, respectively, with the C₄₋₉ fraction directed to gasoline, the C₇₋₁₆ fraction directed to jet fuels, and the C₁₁₋₂₄ fraction directed to diesel fuel and other industrial applications, such as chemicals. Examples of various C₄₊ alkanes and C₄₊ alkenes include, without limitation, butane, butene, pentane, pentene, 2-methylbutane, hexane, hexene, 2-methylpentane, 3-methylpentane, 2,2-dimethylbutane, 2,3-dimethylbutane, heptane, heptene, octane, octene, 2,2,4,-trimethylpentane, 2,3-dimethyl hexane, 2,3,4-trimethylpentane, 2,3-dimethylpentane, nonane, nonene, decane, decene, undecane, undecene, dodecane, dodecene, tridecane, tridecene, tetradecane, tetradecene, pentadecane, pentadecene, hexadecane, hexadecene, heptyldecane, heptyldecene, octyldecane, octyldecene, nonyldecane, nonyldecene, eicosane, eicosene, uneicosane, uneicosene, doeicosane, doeicosene, trieicosane, trieicosene, tetraeicosane, tetraeicosene, and isomers thereof.

C₅₊ cycloalkanes and C₅₊ cycloalkenes produced from acid condensation can have from 5 to 30 carbon atoms and may be unsubstituted, mono-substituted or multi-substituted. In the case of mono-substituted and multi-substituted compounds, the substituted group may include a branched C₃₊ alkyl, a straight chain C₁₊ alkyl, a branched C₃₊ alkylene, a straight chain C₂₊ alkylene, a phenyl or a combination thereof. By way of example, at least one of the substituted groups include a branched C₃₋₁₂ alkyl, a straight chain C₁₋₁₂ alkyl, a branched C₃₋₁₂ alkylene, a straight chain C₁₋₁₂ alkylene, a straight chain C₂₋₁₂ alkylene, a phenyl or a combination thereof. By way of further example, at least one of the substituted groups include a branched C₃₋₄ alkyl, a straight chain C₁₋₄ alkyl, a branched C₁₋₄ alkylene, straight chain C₁₋₄ alkylene, straight chain C₂₋₄ alkylene, a phenyl or a combination thereof. Examples of desirable C₅₊ cycloalkanes and C₅₊ cycloalkenes include, without limitation, cyclopentane, cyclopentene, cyclohexane, cyclohexene, methyl-cyclopentane, methyl-cyclopentene, ethyl-cyclopentane, ethyl-cyclopentene, ethyl-cyclohexane, ethyl-cyclohexene, propyl-cyclohexane, butyl-cyclopentane, butyl-cyclohexane, pentyl-cyclopentane, pentyl-cyclohexane, hexyl-cyclopentane, hexyl-cyclohexane, and isomers thereof.

Aryls will generally consist of an aromatic hydrocarbon in either an unsubstituted (phenyl), mono-substituted or multi-substituted form. In the case of mono-substituted and multi-substituted compounds, the substituted group may include a branched C₃₊ alkyl, a straight chain C₁₊ alkyl, a branched C₃₊ alkylene, a straight chain C₂₊ alkylene, a phenyl or a combination thereof. By way of example, at least one of the substituted groups include a branched C₃₊ alkyl, a straight chain C₁₋₁₂ alkyl, a branched C₃₋₁₂ alkylene, a straight chain C₂₋₁₂ alkylene, a phenyl or a combination thereof. By way of further example, at least one of the substituted groups include a branched C₃₋₄ alkyl, a straight chain C₁₋₄ alkyl, a branched C₃₋₄ alkylene, straight chain C₂₋₄ alkylene, a phenyl or a combination thereof. Examples of various aryls include, without limitation, benzene, toluene, xylene (dimethylbenzene), ethyl benzene, para xylene, meta xylene, ortho xylene, C₉₊ aromatics, butyl benzene, pentyl benzene, hexyl benzene, heptyl benzene, octyl benzene, nonyl benzene, decyl benzene, undecyl benzene, and isomers thereof.

Fused aryls will generally consist of bicyclic and polycyclic aromatic hydrocarbons, in either an unsubstituted, mono-substituted, or multi-substituted form. In the case of mono-substituted and multi-substituted compounds, the substituted group may include a branched C₃₊ alkyl, a straight chain C₁₊ alkyl, a branched C₃₊ alkylene, a straight chain C₂₊ alkylene, a phenyl or a combination thereof. By way of example, at least one of the substituted groups include a branched C₃₋₄ alkyl, a straight chain C₁₋₄ alkyl, a branched C₃₋₄ alkylene, straight chain C₂₋₄ alkylene, a phenyl or a combination thereof. Examples of various fused aryls include, without limitation, naphthalene, anthracene, and isomers thereof.

Polycyclic compounds will generally consist of bicyclic and polycyclic hydrocarbons, in either an unsubstituted, mono-substituted, or multi-substituted form. Although polycyclic compounds generally include fused aryls, as used herein the polycyclic compounds generally have at least one saturated or partially saturated ring. In the case of mono-substituted and multi-substituted compounds, the substituted group may include a branched C₃₊ alkyl, a straight chain C₁₊ alkyl, a branched C₃₊ alkylene, a straight chain C₂₊ alkylene, a phenyl or a combination thereof. By way of example, at least one of the substituted groups include a branched C₃₋₄ alkyl, a straight chain C₁₋₄ alkyl, a branched C₃₋₄ alkylene, straight chain C₂₋₄ alkylene, a phenyl or a combination thereof. Examples of various fused aryls include, without limitation, tetrahydronaphthalene and decahydronaphthalene, and isomers thereof.

The C₄₊ alcohols may also be cyclic, branched or straight chained, and have from 4 to 30 carbon atoms. In general, the C₄₊ alcohols may be a compound according to the formula R¹—OH, wherein R¹ is a member selected from a branched C₄₊ alkyl, straight chain C₄₊ alkyl, a branched C₄₊ alkylene, a straight chain C₄₊ alkylene, a substituted C₅₊ cycloalkane, an unsubstituted C₅₊ cycloalkane, a substituted C₅₊ cycloalkene, an unsubstituted C₅₊ cycloalkene, an aryl, a phenyl or combinations thereof. Examples of desirable C₄₊ alcohols include, without limitation, butanol, pentanol, hexanol, heptanol, octanol, nonanol, decanol, undecanol, dodecanol, tridecanol, tetradecanol, pentadecanol, hexadecanol, heptyldecanol, octyldecanol, nonyldecanol, eicosanol, uneicosanol, doeicosanol, trieicosanol, tetraeicosanol, or isomers thereof.

In some embodiments, a condensation product stream comprising C₄₊ compounds can be fractionated into various product streams, such as gasoline, jet fuel (kerosene), diesel fuel, and aromatics. For example, the condensation product stream may be passed through a three-phase separator to separate the condensation product stream into an acid condensation gas stream, an organic stream, and an aqueous stream. The organic stream and aqueous stream can be separated by density difference, while the acid condensation gas stream comprising uncondensed gases can be recycled to the acid condensation reactor to generate additional C₄₊ compounds. In some embodiments, a gas transport device, such as a blower or compressor, can be configured in the acid condensation gas stream to control the recycle pressure. In some embodiments, an optional purge stream may also be used to control the pressure of the recycle loop in the acid condensation gas stream. In some embodiments, the aqueous stream is discarded from the process, or further processed in downstream process units.

In some embodiments, the organics stream is fractionated in a distillation column to separate the organic stream into a light product stream and a heavy product stream. In some embodiments, the distillation unit is configured to remove co-boiling contaminants for benzene, toluene, or a combination thereof.

In some embodiments, the distillation column is configured to generate a heavy stream that is free or substantially free of co-boiling non-aromatic contaminants for benzene. The distillation column may remove co-boiling nonaromatic contaminants for benzene by fractionating the organic stream into a C₆₋ stream comprising benzene, co-boiling non-aromatic contaminants for benzene, and lighter products through the light product stream. The distillation column may further fractionate the organic stream into a heavy product stream comprising C₇₊ compounds.

In some embodiments, the distillation column is configured to generate a heavy stream that is free or substantially free of co-boiling nonaromatic contaminants for toluene. The distillation column may remove co-boiling nonaromatic contaminants for toluene by fractionating the organic stream into a C₇₋ or C₈₋ stream comprising toluene, co-boiling nonaromatic contaminants for toluene, and lighter products through the light product stream. The distillation column may further fractionate the organic stream into a heavy product stream comprising C₈₊ or C₉₊ compounds.

In some embodiments, the heavy product stream is fractionated in a distillation column to separate the heavy product stream comprising C₇₊ compounds, C₈₊ compounds, or C₉₊ compounds into the mixed aromatic feed stream and a heavy product stream. In some embodiments, the distillation column is configured to fractionate the heavy product stream 140 into a mixed aromatic feed stream 16 comprising C₇₊ compounds and a heavy product feed stream comprising C₁₁₊ compounds. In some embodiments, the mixed aromatic feed stream comprises C₇₊ compounds, or C₈₊ compounds, or C₉₊ compounds, or C₇₋₁₀ compounds, or C₈₋₁₀ compounds, or C₉₋₁₀ compounds.

In some embodiments, the heavy stream may be further separated for use as kerosene (e.g., C₁₁₋₁₄ as jet fuel use), diesel fuel use (e.g., C₁₂₋₂₄), and lubricants or fuel oils (e.g., C₂₅₊). Alternatively, the heavy stream may be cracked to produce addition fractions for use in gasoline, kerosene, aromatics, and/or diesel fractions.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a”, “an”, and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms.

The present invention has been described in terms of one or more preferred embodiments, and it should be appreciated that many equivalents, alternatives, variations, and modifications, aside from those expressly stated, are possible and within the scope of the invention.

### EXAMPLES

The acid condensation catalyst gradually accumulates deposits of coke as the reaction proceeds. Each reactor of at least 3 reactors is in the lead position for a period (e.g., 24 hours) after which it needs to be regenerated to burn the accumulated coke. The coke is burned off at high temperature in a large circulating volume of inert gas with a low concentration of oxidant.

In some cases, the inert gas is nitrogen, and the oxidant is air. The air can be supplied via an air compressor. Nitrogen can be supplied by nitrogen supply system on site. They are fed to the regeneration system using a large make-up air compressor using air from the atmosphere. It was discovered that by replacing the nitrogen and air with carbon dioxide (CO₂) and oxygen the vapor circulation rate to keep the bed exotherm at about 110° C. was reduced by a third. This meant that the regeneration circulation could be one third smaller, along with all of the piping and heat exchangers in the regeneration circuit. The need for a make-up air compressor was dispensed with altogether. CO₂ and oxygen could be sourced at pressure from the H₂ plant CO₂ removal unit and the Air Separation Unit (ASU) respectively.

### Example 1: Process Description with Pure Oxygen and Carbon Dioxide Feeds

Referring to FIG. 1, the acid catalyst (AC) regeneration vapor recycle gas (1) from the AC Regeneration Compressor (A) is mixed with pure oxygen feed (2) to achieve an oxygen concentration of 1.30 vol %. The combined stream (4) is heated from 96° C. to 345° C. in the AC Regeneration Feed/Effluent Exchanger (B) by effluent gas (7) leaving the AC Reactor (D). This heated, combined stream (5) is then further heated to 385° C. in the AC Regeneration Fired Heater (C) before entering the AC Reactor (D). Oxygen in the feed gas (6) oxidizes coke on the AC Reactor (D) catalyst in an exothermic reaction, forming carbon dioxide and water.

The gas (7) leaves AC Reactor (D) at 493° C. and is cooled to 269° C. in the AC Regeneration Feed/Effluent Exchanger (B) by AC feed gas (4). The stream (8) is then further cooled to 54° C. against air in the AC Regeneration Cooler (E), to produce stream (9), and then to 40° C. against cooling water in the AC Regeneration Trim Cooler (F). The cooled stream (10) then enters the AC Regeneration KO Drum (G) where vapor/liquid separation is carried out. The water (11) is removed and sent to effluent treatment. A small purge (13) is taken from the vapor stream (12) leaving the AC Regeneration KO Drum (G) to control the pressure in the loop. The remaining vapor (14) is recycled via the AC Regeneration Compressor (A).

Carbon dioxide (3) is used as inert gas to purge oxygen from the AC regeneration loop once all coke has been removed from the AC Reactor catalyst.

### Example 2: Process Description with Air and Nitrogen Feeds

Referring to FIG. 2, air from atmosphere (15) is compressed in the AC Regeneration Make-Up Air Compressor (H) and mixed with AC Regeneration vapor recycle gas (1) from the AC Regeneration Compressor (A) to achieve an oxygen concentration of 0.90 vol %. The combined stream (4) is heated from 109° C. to 345° C. in the AC Regeneration Feed/Effluent Exchanger (B) by effluent gas (7) leaving the AC Reactor (D). This heated, combined stream (5) is then further heated to 385° C. in the AC Regeneration Fired Heater (C) before entering the AC Reactor (D). Oxygen in the feed gas (6) oxidizes coke on the AC Reactor (D) catalyst in an exothermic reaction, forming carbon dioxide and water.

The gas (7) leaves AC Reactor (D) at 494° C. and is cooled to 276° C. in the AC Regeneration Feed/Effluent Exchanger (B) by AC feed gas (4). The stream (8) is then further cooled to 54° C. against air in the AC Regeneration Cooler (E), to produce stream (9), and then to 40° C. against cooling water in the AC Regeneration Trim Cooler (F). The cooled stream (10) then enters the AC Regeneration KO Drum (G) where vapor/liquid separation is carried out. The water (11) is removed and sent to effluent treatment. A small purge (13) is taken from the vapor stream (12) leaving the AC Regeneration KO Drum (G) to control the pressure in the loop. The remaining vapor (14) is recycled via the AC Regeneration Compressor (A).

Nitrogen (3) is used as inert gas to purge oxygen from the AC regeneration loop once all coke has been removed from the AC Reactor catalyst.

### Example 3: Effect of Carbon Dioxide in Regeneration Gas

Carbon dioxide has a higher molar heat capacity than nitrogen at the conditions encountered in the AC Reactor during the AC catalyst regeneration process. Between 380° C. to 540° C. at 15 bara, carbon dioxide has an average molar heat capacity of 50.3 kJ/kmol·K whilst nitrogen has a heat capacity of 31.1 kJ/kmol·K. The AC regeneration gas under Example 2 typically contains about 17 vol % carbon dioxide and 83 vol % nitrogen. If the carbon dioxide concentration were to be increased and the nitrogen content decreased, the heat capacity of the stream would increase. This means that the reactor inlet oxygen concentration can be increased if the inlet gas is richer in carbon dioxide to achieve the same exotherm and exit temperature. This would result in a lower volumetric flow for the same mass of coke removed and allow the AC regeneration equipment sizes to be reduced.

TABLE 1
AC Reactor inlet Temperature, AC Reactor Exit Temperature,
and AC Reactor Exotherm for O₂/CO₂ feeds and air/N₂ feeds.

| | AC Reactor Inlet | AC Reactor Exit | AC Reactor |
|---|---|---|---|
| | Temperature | Temperature | Exotherm |
| | ° C. | ° C. | ° C. |
| Example 1- O₂/CO₂ | 385 | 493 | 108 |
| Example 2 - Air/N₂ | 385 | 494 | 109 |

TABLE 2
AC reactor inlet gas composition for
O₂/CO₂ feeds and air/N₂ feeds.

| | | Carbon | | |
|---|---|---|---|---|
| | Oxygen | Dioxide | Nitrogen | Water |
| | vol % | vol % | vol % | vol % |
| Example 1 - O₂/CO₂ | 1.30 | 98.11 | — | 0.59 |
| Example 2 - Air/N₂ | 0.90 | 16.69 | 81.86 | 0.55 |

TABLE 3
AC Reactor Inlet Gas Heat Capacity and Recycle
Gas Flow for O₂/CO₂ feeds and air/N₂ feeds.

| | AC Reactor Inlet Gas | Recycle Gas Flow | Regen Gas Molar |
|---|---|---|---|
| | Heat Capacity | Nm³ recycle/Nm³ | Flow Relative to |
| | kJ/kmol · K | oxygen added | Example 2 |
| Example 1 - O₂/CO₂ | 48.7 | 75.9 | 69 |
| Example 2 - Air/N₂ | 33.7 | 106.3 | 100 |

From above Tables 1-3 based on simulations, it can be seen that the gas circulation rate has been reduced by 28.6% (measured by recycle gas flow) or 31% (measured by total regeneration gas flow) by the use of pure oxygen and carbon dioxide instead of air and nitrogen. The exotherm across the AC Reactor has been maintained at the upper limit of 110° C.

The use of pure oxygen avoids the need for a dedicated air compressor but it does require a pure oxygen import to be available which may be the case if an ATR type hydrogen plant is used but not if a conventional steam methane reformer is used.

Additional studies were conducted to demonstrate the impact of co-feeding carbon dioxide (CO₂) at various ratios of CO₂ to air in the regeneration gas (Table 4). The studies were categorized into Case A (same condition as Example 1, using pure O₂ feed with CO₂ used for inert purging), Case B (same condition as Example 2, using an air feed with N₂ used for inert purging), and Case C (using an air feed as the O₂ source and a co-feed of CO₂). In Case C, CO₂ is added to prevent N₂ (which enters with the air feed) from building up to high concentrations, and the added CO₂ is also used instead of N₂ for the inert purging steps. As shown in Table 4, CO₂ concentration in the regeneration gas of greater than 30 vol % may result in a significant reduction in the gas circulation (due to higher O₂ concentrations for the same exotherm) and allow the equipment sizes to be reduced relative to Case B.

TABLE 4
Effect of CO₂ in regeneration gas

| | Ratio CO2 | | | | | | | | | AC Regen |
|---|---|---|---|---|---|---|---|---|---|---|
| | feed to Air | | | | | | | | | Loop Gas |
| | feed | AC Reactor | AC Reactor | AC | AC Reactor Inlet Gas Composition | | | | AC Reactor | Flow |
| | kmol | Inlet | Outlet | Reactor | | Carbon | | | Inlet Gas Heat | Molar flow |
| | CO2/kmol | Temperature | Temperature | Exotherm | Oxygen | Dioxide | Nitrogen | Water | Capacity | relative to |
| Case | air | ° C. | ° C. | ° C. | vol % | vol % | vol % | vol % | kJ/kmol · K | Case B |
| A | 0 | 385 | 493 | 108 | 1.300 | 98.11 | — | 0.59 | 48.72 | 69 |
| B | 0 | 385 | 494 | 109 | 0.900 | 16.69 | 81.86 | 0.55 | 33.71 | 100 |
| C1 | 0.05 | 385 | 494 | 109 | 0.925 | 20.72 | 77.80 | 0.55 | 34.45 | 97 |
| C2 | 0.10 | 385 | 495 | 110 | 0.950 | 24.38 | 74.12 | 0.55 | 35.12 | 95 |
| C3 | 0.25 | 385 | 495 | 110 | 1.000 | 33.53 | 64.92 | 0.55 | 36.80 | 90 |
| C4 | 0.50 | 385 | 495 | 110 | 1.050 | 44.62 | 53.79 | 0.54 | 38.83 | 86 |
| C5 | 1.00 | 385 | 493 | 108 | 1.100 | 58.31 | 40.06 | 0.53 | 41.35 | 82 |
| C6 | 2.50 | 385 | 494 | 109 | 1.200 | 75.63 | 22.70 | 0.47 | 44.55 | 75 |
| C7 | 5.00 | 385 | 494 | 109 | 1.250 | 85.18 | 13.18 | 0.38 | 46.31 | 72 |
| C8 | 10.0 | 385 | 495 | 110 | 1.290 | 91.34 | 7.18 | 0.19 | 47.43 | 70 |

### Example 4: Outline of Acid Catalyst Regeneration Process

Regeneration gas consisting of inert gas and a low oxygen concentration is introduced to the AC Reactor at about 16 bara and 385° C. which starts the coke burn. The maximum coke burn rate is limited by the supply rate of oxygen, which is kept constant throughout the coke burn. It is desirable to keep the exotherm to less than 110° C. and to keep the maximum bed temperature lower than about 540° C.

At the beginning of the coke burn, almost all of the oxygen is consumed. As the burn progresses, the inlet temperature needs to be gradually increased to about 430° C. to maintain full oxygen consumption for as long as possible since a range of coke species are present, some of which are easier to burn than others. Bed temperatures are carefully monitored to avoid exceeding the exotherm or maximum bed temperature limit. At a certain point, full oxygen consumption is no longer achievable, and the inlet temperature is further increased until it reaches 470° C. Note that the exotherm is much reduced during this final stage of the burn as there is no longer full consumption of oxygen.

The regeneration is complete once the final inlet temperature of 470° C. has been reached and there is minimal oxygen consumption across the AC Reactor. After this, an inert purge of the AC regeneration loop, including the AC Reactor, is carried out to remove oxygen from the system.

### Example 5: Alternative Means to Achieve Similar Benefits

In Example 2, as described above, air is used as the source of oxygen which therefore introduces nitrogen to the system. As the coke burn progresses and carbon dioxide is produced, the concentration of carbon dioxide in the AC regeneration loop increases to a maximum of about 17 vol %. due to the relative ratios of make-up air and vapor purge to maintain system pressure. An alternative way to obtain a similar benefit would be to co-feed carbon dioxide and air to counteract the addition of nitrogen from the air supply. This would lead to a higher carbon dioxide concentration in the AC regeneration gas but require a continuous supply of carbon dioxide during the regeneration process.

### Example 6: Experimental Results

Lab-scale reactors were used to carry out AC catalyst regenerations to compare the exotherms when using a 1.0 vol % O₂ in N₂ blend and a 1.3 vol % O₂ in CO₂ blend. It was hypothesized that the exotherms would be very similar.

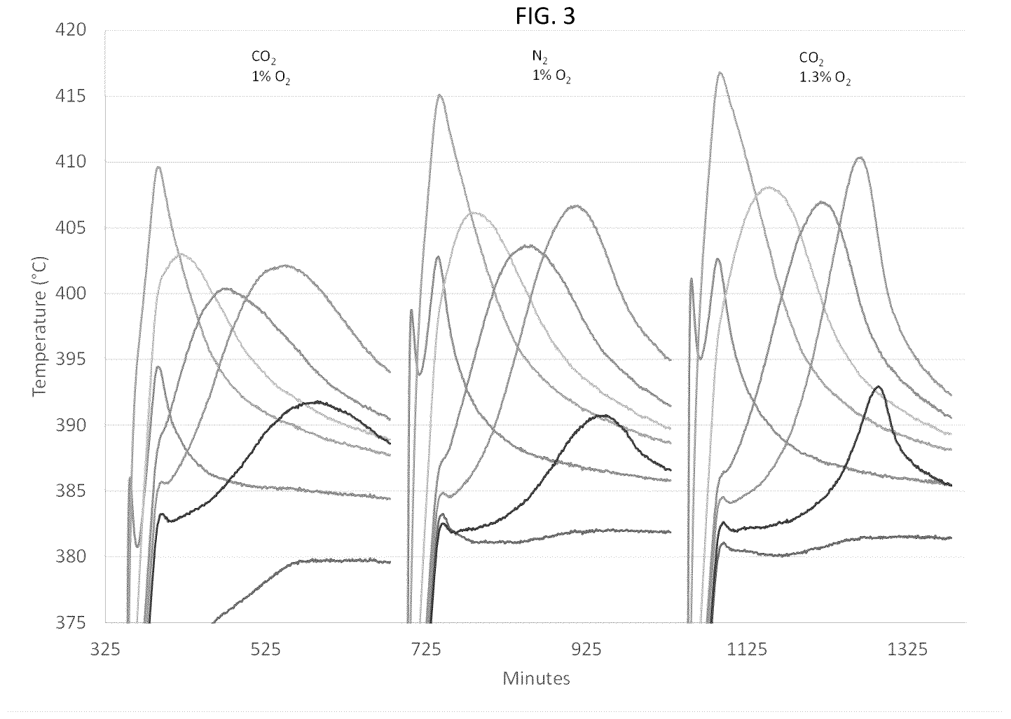

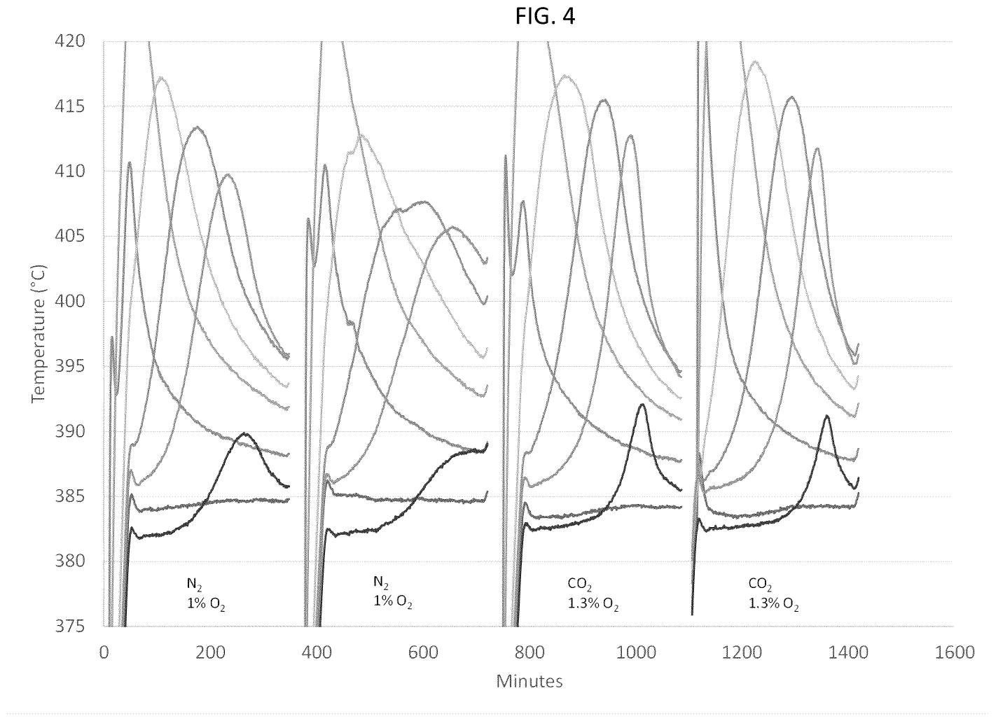

FIGS. 3-4 show the results of several of these regenerations with each chart representing 1 of the 3 reactors that are present. It can be seen that the exotherms are indeed very similar thus demonstrating that the expected benefits can be seen in practice. The oxygen consumption was similar for regenerations using either blend and that process performance of the regenerated catalyst was also similar and so the use of a CO₂ rich regeneration gas presented no negative impacts on process performance.

What is claimed is:

1. A method of regenerating an acid condensation (AC) catalyst, the method comprising:
(i) reacting a fouled acid condensation catalyst in an AC reactor with a regeneration feed gas comprising oxygen (O₂) at a regeneration temperature to produce a regenerated acid condensation catalyst and an effluent gas comprising carbon dioxide (CO₂);
(ii) fractionating the effluent gas into a liquid phase containing water and a vapor phase;
(iii) mixing at least a portion of the vapor phase with O₂, CO₂, air, or a combination thereof to form the regeneration feed gas; and
(iv) introducing the regeneration feed gas to the AC reactor to continue the reaction of step (i).

2. The method of claim 1, wherein the regeneration gas is heated by the effluent gas in a heat exchanger before entering the AC reactor as the regeneration gas.

3. The method of claim 1, wherein the regeneration gas is heated by a heater to an inlet temperature of about 350° C. to about 500° C.

4. The method of claim 1, wherein the vapor phase is mixed with O₂ in step (iii).

5. The method of claim 1, wherein the vapor phase is mixed with air in step (iii).

6. The method of claim 1, wherein the vapor phase is mixed with O₂ and CO₂ in step (iii).

7. The method of claim 1, wherein the vapor phase is mixed with air and CO₂ in step (iii).

8. The method of claim 1, wherein O₂ in the regeneration feed gas is about 0.5 vol % to about 5.0 vol %.

9. The method of claim 1, wherein CO₂ in the regeneration feed gas is about 5 vol % to about 99 vol %.

10. The method of claim 1, where the regeneration feed gas has an inlet gas heat capacity of about 30 kJ/kmol·K to about 50 kJ/kmol·K.

11. The method of claim 1, wherein the vapor phase is compressed by a compressor before the mixing in step (iii).

12. The method of claim 1, wherein the effluent gas exiting the AC reactor has a temperature of about 470° C. to about 560° C.

13. The method of claim 1, wherein the effluent gas is cooled to about 40° C. before being fractionated in step (ii).

14. The method of claim 1, wherein a portion of the vapor phase from step (ii) is purged and the remaining vapor phase is used in step (iii).

15. The method of claim 1, wherein the acid condensation catalyst comprises carbides, nitrides, zirconia, alumina, silica, aluminosilicates, phosphates, zeolites, titanium oxides, zinc oxides, vanadium oxides, lanthanum oxides, yttrium oxides, scandium oxides, magnesium oxides, cerium oxides, barium oxides, calcium oxides, hydroxides, heteropolyacids, inorganic acids, and combinations thereof.

16. The method of claim 15, wherein the acid condensation catalyst further comprises a modifier selected from the group consisting of Ce, La, Y, Sc, P, B, Bi, Li, Na, K, Rb, Cs, Mg, Ca, Sr, Ba, and a combination thereof.

17. The method of claim 8, wherein O₂ in the regeneration feed gas is about 1.0 vol % to about 1.5 vol %.

18. The method of claim 9, wherein CO₂ in the regeneration feed gas is about 90 vol % to about 99 vol %.

19. A method of producing a C₄₊ compound, the method comprising:
(i) reacting a feed stream comprising C₁₊O₁₋₃ hydrocarbons in the presence of an acid condensation catalyst at a condensation temperature and condensation pressure to produce an AC product stream comprising the C₄₊ compound and a fouled acid condensation catalyst;
(ii) regenerating the fouled acid condensation catalyst according to the method of claim 1 to produce a regenerated acid condensation catalyst; and
(iii) continue reacting the feed stream in the presence of the regenerated acid condensation catalyst to further produce the AC product stream comprising the C₄₊ compound.

20. The method of claim 19, wherein the feed stream is derived from biomass.
